(19) United States
(12) Patent Application Publication
(10) Pub. No.: US 2009/0239396 A1
(43) Pub. Date: Sep. 24, 2009

(54) Compression Connector

(76) Inventors: Koon Poh Tay, Singapore (SG); Kiat Hup Joey Ng, Singapore (SG); Yoke Pheng Louis Ng, Singapore (SG)

Correspondence Address: Harrington & Smith PC, 4 Research Drive, Suite 202, Shelton, CT, 06484, US

(21) Appl. No.: 12/224,974

(22) PCT Filed: Jan. 29, 2007
(86) PCT No.: PCT/SG2007/000028

§ 371 Date: Feb. 13, 2009

(30) Foreign Application Priority Data
Mar. 9, 2006 (SG) 200601573-9

(51) Int. Cl. H01R 12/00

(52) U.S. Cl. 439/66; 439/816

(57) ABSTRACT

A compression connector, a terminal for a compression connector and an assembly including a compression connector and a PCB. The compression connector including a housing; one or more terminals disposed in the housing; each terminal including a substantially U-shaped contact portion protruding above a surface level of the housing with a close end of the substantially U-shaped contact portion facing away from the housing, the substantially U shaped contact portion including a first leg connected to a main body of said each terminal and a second leg having a free end, the free end being disposed substantially at or below the surface level of the housing; wherein the first and second legs are angled with respect to each other in a quiescent state and such that the first and second legs are substantially parallel to each other in a contact state where the substantially U-shaped contact portion resiliently engages a contact through-hole of a PCB.

### FIELD OF INVENTION

The present invention relates broadly to a compression connector, a terminal for a compression connector and an assembly comprising a compression connector and a PCB.

### BACKGROUND

Typically, electrical connection between a Printed Circuit Board (PCB) and a compression connector is achieved by receiving portions of terminals of the connector in corresponding holes or openings in the PCB. The contact portions of the terminals are dimensioned to fit into the openings in the PCB for electrical connection with contact traces of the PCB.

However, there is a disadvantage of low manufacturing tolerances in both the openings in the PCB and the dimensioning of the contact portions to ensure electrical connection. Thus, it requires a stringent precision manufacturing process which will add to the complexity of the PCB and the connector fabrication.

In addition, there is an issue of unwanted disengagement between the PCB and the connector which can result in an open circuit. An additional member such as a clamp may be used to retain the connector to the PCB to prevent unwanted disengagement between the connector and the PCB. However, this will lead to an undesirable additional step in the assembly process and the usage of an additional member.

Therefore, there is a need to provide a compression connector designed to address at least one of the above-mentioned problems.

### SUMMARY

In accordance with a first aspect of the present invention, there is provided a compression connector comprising: a housing; one or more terminals disposed in the housing; each terminal comprising a substantially U-shaped contact portion protruding above a surface level of the housing with a close end of the substantially U-shaped contact portion facing away from the housing, the substantially U shaped contact portion comprising a first leg connected to a main body of said each terminal and a second leg having a free end, the free end being disposed substantially at or below the surface level of the housing; wherein the first and second legs are angled with respect to each other in a quiescent state and such that the first and second legs are substantially parallel to each other in a contact state where the substantially U-shaped contact portion resiliently engages a contact through-hole of a PCB.

The substantially U-shaped contact portion may comprise a protrusion extending outwardly from the substantially U-shaped contact portion.

The protrusion may be disposed on the second leg of the substantially U-shaped contact portion.

The protrusion may be disposed on the second leg to achieve a force distribution within the PCB for preventing deformation of the terminal when the substantially U-shaped contact portion resiliently engages the though-hole.

The first leg of the substantially U-shaped contact portion may extend substantially perpendicularly from the housing, and the second leg of the substantially U-shaped contact portion may be angled with respect to the first leg.

The terminal may further comprise a solder tail portion extending beyond the housing.

The terminal further may comprise a curved portion between the substantially U-shaped contact portion and the solder tail portion for resiliently supporting the substantially U-shaped contact portion.

A plurality of terminals may be disposed in two rows along the housing.

The terminals may be arranged such that the orientation of the terminals is rotated by about 180° in one row with respect to the other row.

The terminals are arranged such that a substantially even force distribution is achieved when the substantially U-shaped contact portions resiliently engage the through-holes of the PCB.

In accordance with a second aspect of the present invention, there is provided a terminal for a compression connector, the terminal comprising: a substantially U-shaped contact portion for protruding above a surface level of a housing of the connector with a close end of the substantially U-shaped contact portion facing away from the housing, the substantially U shaped contact portion comprising a first leg connected to a main body of said each terminal and a second leg having a free end, the free end being disposed substantially at or below the surface level of the housing; wherein the first and second legs are angled with respect to each other in a quiescent state and such that the first and second legs are substantially parallel to each other in a contact state where the substantially U-shaped contact portion resiliently engages a contact through-hole of a PCB.

The substantially U-shaped contact portion may comprise a protrusion extending outwardly from the substantially U-shaped contact portion.

The protrusion may be disposed on the second leg of the substantially U-shaped contact portion.

The protrusion may be disposed on the second leg to achieve a force distribution within the PCB for preventing deformation of the terminal when the substantially U-shaped contact portion resiliently engages the though-hole.

The first leg of the substantially U-shaped contact portion may extend substantially perpendicularly from the housing, and the second leg of the substantially U-shaped contact portion may be angled with respect to the first leg.

The terminal may further comprise a solder tail portion extending beyond the housing.

The terminal may further comprise a curved portion between the substantially U-shaped contact portion and the solder tail portion for resiliently supporting the substantially U-shaped contact portion.

In accordance with a third aspect of the present invention, there is provided an assembly comprising: a compression connector; a PCB; wherein the compression connector comprises: a housing; one or more terminals disposed in the housing; each terminal comprising a substantially U-shaped contact portion protruding above a surface level of the housing with a close end of the substantially U-shaped contact portion facing away from the housing, the substantially U shaped contact portion comprising a first leg connected to a main body of said each terminal and a second leg having a free end, the free end being disposed substantially at or below the surface level of the housing; wherein the first and second legs are angled with respect to each other in a quiescent state and such that the first and second legs are substantially parallel to each other in a contact state where the substantially U-shaped contact portion resiliently engages a contact through-hole of a PCB.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram of a compression connector before assembly with a PCB, the PCB shown in cross-section.

FIG. 2 shows a schematic cross-sectional view of an assembly of the compression connector and the PCB in a mated condition.

FIG. 3 shows a schematic perspective cross-sectional view of the assembly of the compression connector and the PCB in the mated condition.

### DETAILED DESCRIPTION

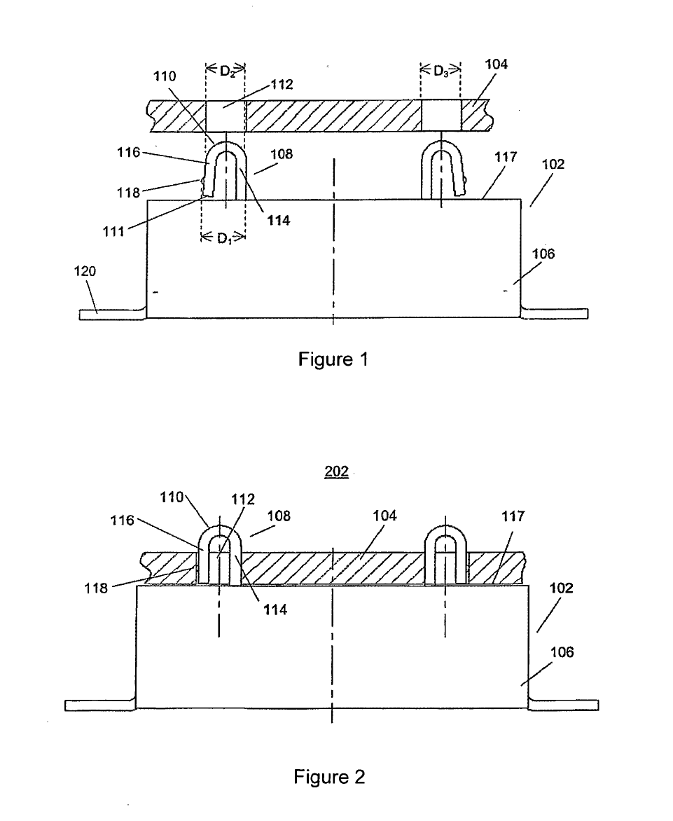

FIG. 1 shows a schematic view of a compression connector 102 before assembling with a PCB 104, the PCB 104 shown in cross-section. The compression connector 102 comprises a housing 106 and one or more terminals 108 disposed in the housing 106.

The housing 106 is made of high temperature engineering plastic. Other non-conductive materials such as, but not limited to, generic engineering plastics, e.g. Liquid Crystal Polymer (LCP), may be used for manufacturing the housing 106. It will be appreciated by a person skilled in the art that the housing 106 can be manufactured using known methods including but not limited to e.g. casting and molding.

The terminal 108 is made from copper alloy. Other conductive materials including, but not limited to, phosphor bronze, and/or gold or tin plated materials may be used for manufacturing the terminal 108. It will be appreciated by the person skilled in the art that the terminal 108 can be manufactured using known methods including but not limited to e.g. cutting and press forming.

The terminal 108 comprises a substantially U-shaped contact portion 110 which protrudes above the housing 106 with a closed end of the contact portion 110 facing away from the housing 106.

A first leg 114 of the contact portion 110 extends substantially perpendicularly from the housing 106. A second leg 116 of the contact portion 110 having a free end 111 is angled with respect to the first leg 114 of the U-shaped contact portion 110 in a quiescent state. The first leg 114 and the second leg 116 are arranged such that a width D₁ of an open end of the contact portion 110 is greater than a width D₂ of the closed end of the contact portion 110 and a width D₃ of the through-hole 112 is equal to or larger than the width D₂ of the closed end of the contact portion 110 but is smaller than the width D₁ of the open end of the contact portion 110. The second leg 116 terminates substantially at a surface level 117 of the housing 106.

As will be appreciated by a person skilled in the art, such an arrangement of the first and second legs 114, 116 of the contact portion 110 advantageously provides a resilient engagement between the contact portion 110 and a through-hole 112 of the PCB 104, when the PCB 104 and the contact portion 110 are in a mated condition. The resilient engagement can ensure electrical contact between the contact portion 110 and contact traces (not shown) of the PCB 104. The contact traces (not shown) of the PCB 104 are plated on an inner surface of the through-hole 112 for providing electrical connection. The resilient engagement provides a clipping effect which can reduce the likelihood of unwanted disengagement from the PCB 104.

The contact portion 110 further comprises a protrusion 118, which is disposed on the second leg 116 of the contact portion 110. The protrusion 118 extends outwardly from the second leg 116 of the contact portion 110. It will be appreciated by the person skilled in the art that the protrusion 118 will advantageously further facilitate a resilient engagement between the contact portion 110 and the through-hole 112 of the PCB 104.

The terminal 108 further comprises a solder tail portion 120 extending beyond the housing 106. An electrical connection of the compression connector 102 with another PCB (not shown) can be achieved by soldering the solder tail portion 120 onto the PCB (not shown). The solder tail portion 120 is of the surface mount type. It will be appreciated that other solder tail portion configurations are possible.

FIG. 2 shows a schematic cross-sectional view of an assembly 202 of the compression connector 102 and the PCB 104. During the assembling of the compression connector 102 and the PCB 104, the U-shaped contact portion 110 is compressed so that the contact portion 110 can be fitted into the through-hole 112 of the PCB 104.

After the contact portion 110 is inserted into the through-hole 112, the first and second legs 114, 116 of the contact portion 110 are substantially parallel. With the second leg 116 terminating substantially at the surface level 117 of the housing 106, the contact portion 110 can be manufactured with a lower height while providing a reliable electrical connection between the contact portion 110 and the PCB 104. With the first and second legs 114, 116 being substantially parallel when the PCB 104 and the contact portion 110 are in a mated condition, a resilient engagement between the contact portion 110 and a through-hole 112 of the PCB 104 is advantageously provided, and the reliable electrical connection provided.

The protrusion 118 of the second leg 116 and the first leg 114 are contacting the through-hole 112. The protrusion 118 advantageously achieves a force distribution within the PCB 104 which can advantageously prevent deformation of the terminal 108. It will be appreciated by a person skilled in the art that while the protrusion 118 is shown in FIG. 2 at a mid point along the through-hole 112, the protrusion 118 can be disposed at any determined location along the through-hole 112.

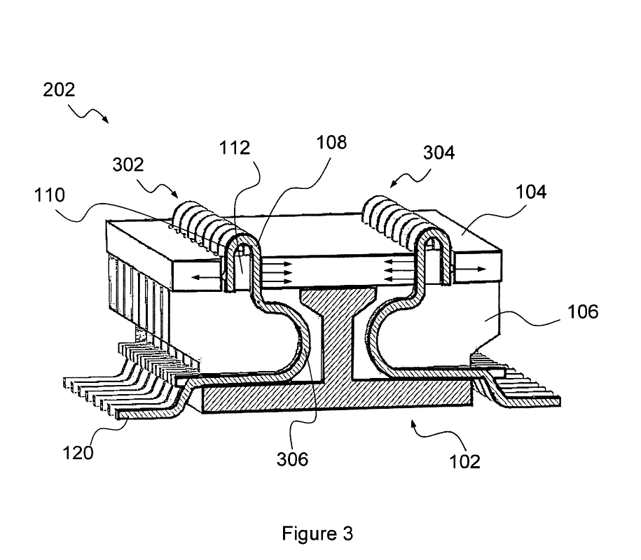

FIG. 3 shows a schematic perspective cross-sectional view of an assembly 202 of the compression connector 102 and the PCB 104. A plurality of terminals 108 is disposed in two rows along the housing 106. The terminals 108 are arranged such that the orientation of the terminals 108 in a first row 302 is rotated by 180° with respect to a second row 304. As will be appreciated by the skilled person in the art, the arrangement of the terminals 108 advantageously achieves the force distribution, indicated by the arrows within the PCB 104 in FIG. 3, which can advantageously prevent deformation of the terminal 108 when the substantially U-shaped contact portions 110 resiliently engage the through-holes 112 of the PCB 104.

As shown in FIG. 3, the terminal 108 further comprises a curved portion 306 between the contact portion 110 and the solder tail portion 120 for resiliently supporting the contact portion 110.

The described connector and terminals provide a resilient engagement between the contact portions of the terminals and the through-holes of the PCB. Unwanted disengagement can be prevented without having to use an additional component such as a clamp to retain the connector to the PCB. A force distribution within the PCB for preventing deformation of the terminal is also achieved.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

It will be appreciated that modifications of the contact portions of the terminals are possible. For example, the contact portions can comprise a protrusion dimensioned so as to provide resilient engagement with an opening of a PCB. Similarly, the contact portions may comprise only one leg angled with respect to a second leg for resilient engagement without a protrusion. The leg having the free end may terminate below the surface level of the housing.

To provide resilient engagement, it is possible that the contact portions may comprise two angled legs and/or more than one protrusion.

Also, the shapes of the terminals and/or the housings are not limited. Other shapes can be used, including differently shaped contact portions, curved portions and solder tail portions.

Furthermore, it will be appreciated that different numbers of terminals per housing may be implemented.

1-18. (canceled)

19. A compression connector comprising:
a housing;
one or more terminals disposed in the housing;
each terminal comprising a substantially U-shaped contact portion protruding above a surface level of the housing with a close end of the substantially U-shaped contact portion facing away from the housing, the substantially U shaped contact portion comprising a first leg connected to a main body of said each terminal and a second leg having a free end, the free end being disposed substantially at or below the surface level of the-housing;
wherein the first and second legs are angled with respect to each other in a quiescent state and that the first and second legs move toward each other in a contact state where the substantially U-shaped contact portion resiliently engages a contact through-hole of a PCB.

20. The compression connector as claimed in claim 19, wherein the first and second legs are angled with respect to each other in a quiescent state and that the first and second legs are substantially parallel to each other in a contact state where the substantially U-shaped contact portion resiliently engages a contact through-hole of a PCB.

21. The compression connector as claimed in claim 19, wherein the substantially U-shaped contact portion comprises a protrusion extending outwardly from the substantially U-shaped contact portion.

22. The compression connector as claimed in claim 20, wherein the protrusion is disposed on the second leg of the substantially U-shaped contact portion.

23. The compression connector as claimed in claim 21, wherein the protrusion is disposed on the second leg to achieve a force distribution within the PCB for preventing deformation of the terminal when the substantially U-shaped contact portion resiliently engages the though-hole.

24. The compression connector as claimed in claim 19, wherein the first leg of the substantially U-shaped contact portion extends substantially perpendicularly from the housing, and the second leg of the substantially U-shaped contact portion is angled with respect to the first leg.

25. The compression connector as claimed in claim 19, wherein the terminal further comprises a solder tail portion extending beyond the housing and a curved portion between the substantially U-shaped contact portion and the solder tail portion for resiliently supporting the substantially U-shaped contact portion.

26. The compression connector as claimed in claim 19, wherein the terminals are arranged such that a substantially even force distribution is achieved when the substantially U-shaped contact portions resiliently engage the through-holes of the PCB.

27. A terminal for a compression connector, the terminal comprising:
a substantially U-shaped contact portion having a first leg connected to a main body of said terminal and a second leg having a free end;
wherein the first and second legs are angled with respect to each other in a quiescent state and that the first and second legs move toward each other in a contact state where the substantially U-shaped contact portion resiliently engages a contact through-hole of a PCB.

28. The terminal as claimed in claim 27, wherein the substantially U-shaped contact portion comprises a protrusion extending outwardly from the substantially U-shaped contact portion.

29. The terminal as claimed in claim 28, wherein the protrusion is disposed on the second leg of the substantially U-shaped contact portion.

30. The terminal as claimed in claim 29, wherein the protrusion is disposed on the second leg to achieve a force distribution within the PCB for preventing deformation of the terminal when the substantially U-shaped contact portion resiliently engages the though-hole.

31. The terminal as claimed in claim 27, wherein the first leg of the substantially U-shaped contact portion extends substantially perpendicularly from the housing, and the second leg of the substantially U-shaped contact portion is angled with respect to the first leg.

32. The terminal as claimed in claim 27, further comprising a solder tail portion extending beyond the housing and a curved portion between the substantially U-shaped contact portion and the solder tail portion for resiliently supporting the substantially U-shaped contact portion.

33. An assembly comprising:
a compression connector;
a PCB;
wherein the compression connector comprises:
a housing;
one or more terminals disposed in the housing;
each terminal comprising a substantially U-shaped contact portion protruding above a surface level of the housing with a close end of the substantially U-shaped contact portion facing away from the housing, the substantially U shaped contact portion comprising a first leg connected to a main body of said each terminal and a second leg having a free end, the free end being disposed substantially at or below the surface level of the housing;
wherein the first and second legs are angled with respect to each other in a quiescent state and that the first and second legs move to each other in a contact state where the substantially U-shaped contact portion resiliently engages a contact through-hole of the PCB.
